(19) United States
(12) Patent Application Publication
(10) Pub. No.: US 2003/0228448 A1
(43) Pub. Date: Dec. 11, 2003

(54) Foamed chiller insulative assemblies

(75) Inventor: James W. Otter, Fairfield Glade, TN (US)

Correspondence Address: WALL MARJAMA & BILINSKI, 101 SOUTH SALINA STREET, SUITE 400, SYRACUSE, NY, 13202, US

(73) Assignee: Carrier Corporation

(21) Appl. No.: 10/165,125

(22) Filed: Jun. 7, 2002

(51) Int. Cl. B32B 3/00; B29C 44/14

(52) U.S. Cl. 428/174; 264/46.4; 264/46.7; 156/78

(57) ABSTRACT

Provision is made for the thermal insulation of a non-planar portion of a body by fabricating a molded insulative piece which fits closely over the non-planar portion and may be secured thereto by way of an adhesive. A thermosetting foam which is adaptable to this use but is susceptible to damage by exposure to sunlight and to abrasive wear, is protected by an outer protective covering that may be integrally formed with a foam core section during the molding process.

### FIELD OF THE INVENTION

This invention relates generally to methods and apparatus for thermally insulating a body and, more particularly, to a manner in which insulative material can be applied to irregular shapes.

### BACKGROUND OF THE INVENTION

In air conditioning systems where various components may have their temperature maintained in a cooled condition with respect to their surrounding environment, it is desirable to provide insulative materials around those components to preventive the loss of energy, and thus efficiency, of the system. Where those components have surfaces that are generally planar in form, it is relatively easy to attach, by an adhesive or the like, flat sheets of insulative material. However, where the shapes of those components are other than planar, such as specially shaped portions of chillers, tanks, heat exchangers etc, the attachment of insulating material thereto becomes more complicated. That is, insulation affixed with adhesive does not adhere well to areas that have even a slightly complex geometry. In order to accomplish this effectively, it has been necessary that the substrate be very clean and dry, thereby requiring a great deal of labor to prepare and affix such commonly used sheet insulation to complex shapes.

Another possible approach is that of providing some kind of form around the complex shape and installing liquid foam which will tend to adhere to the complex shape as the foam dries. A problem with this approach is that the foams that are conducive to this operation are generally “hazardous” chemicals that are difficult to use in a production area and require specially trained personnel. Further, these types of foam are difficult and expensive to make flame retardant, Ultra Violet (UV)-resistant and abrasion resistant.

It is therefore an object of the present invention to provide an improved insulative method and apparatus for complex shaped bodies to be insulated.

Another object of the present invention is the provision for installing insulative materials to complex shapes in such a manner that they remain in the installed position.

Yet another object of the present invention is the provision for the use of insulative materials that are effective and non hazardous during installation and operation.

Still another object of the present invention is the provision for applying insulative materials to complex shaped bodies in an effective and efficient manner.

These objects and other features and advantages become more readily apparent upon reference to the following description when taken in conjunction with the appended drawings.

### SUMMARY OF THE INVENTION

Briefly, in accordance with one aspect of the invention, a pair of mold patterns are fabricated with each having a surface that corresponds to the shape of a non-planar portion of the body to be insulated. That is, the male pattern element is formed with an outer surface corresponding to such shape, while the matching female pattern has an inner surface corresponding to that shape. The two patterns are then brought together with an offset space therebetween being equal to the thickness of the insulation that is desired. A liquid foam material is then injected into the cavity between the two patterns and the foam is then allowed to dry. After the patterns are removed, the resulting insulative section is placed over the non-planar portion of the body and fastened in place with adhesive or the like.

In accordance with another aspect of the invention, urethane foam is used in the process since it is flame retardent and will not pose a fire hazard during the fabrication process or when in operational use.

But yet another aspect of the invention, since most thermosetting foams do not resist ultra violet degradation and abrasion, it is desirable to provide protection against such damage. Accordingly, as part of the process, a metal or plastic shield is formed, again to conform to the shape of the non-planar portion, and placed on the inner side of the female pattern element. When the liquid foam is injected into the cavity, it will press against one side of the plastic or metal shield element and when dried will adhere to that element. When the molded insulative material has been placed on the non-planar portion, the plastic or metal element will remain on it's outer side to thereby protected it from exposure to the sun and to abrasion.

In the drawings as hereinafter described, a preferred embodiment is depicted; however, various other modification and alternate constructions can be made thereto without departing from true spirit and scope of the invention.

### BRIEF DESCRIPTION OF THE DRAWINGS

FIG. 1 is a schematic illustration of a structure to be insulated, including a non-planar portion

FIG. 2 is a male mold element for use in forming a molded insulation panel in accordance with the present invention.

FIG. 3 shows a combination of a male and female mold element prior to being filled with a liquid insulating material in accordance with the present invention.

FIG. 4 is a finished insulation panel as attached to the non-planer portion of the structure to be insulated in accordance with the present invention.

FIG. 5 is a perspective view of an insulating panel that is formed in accordance with the present invention.

FIG. 6 is a alternate embodiment of a non-planer structure to be insulated.

FIG. 7 is a top view of such a structure with planar insulating panels installed.

FIG. 8 is an elevationial view of a mold to be used in accordance with the present invention.

FIG. 9 is an end view of a insulating panel formed in accordance with the present invention.

FIG. 10 is a perspective view of an insulating panel fabricated in accordance with the present invention.

### DESCRIPTION OF THE PREFERRED EMBODIMENT

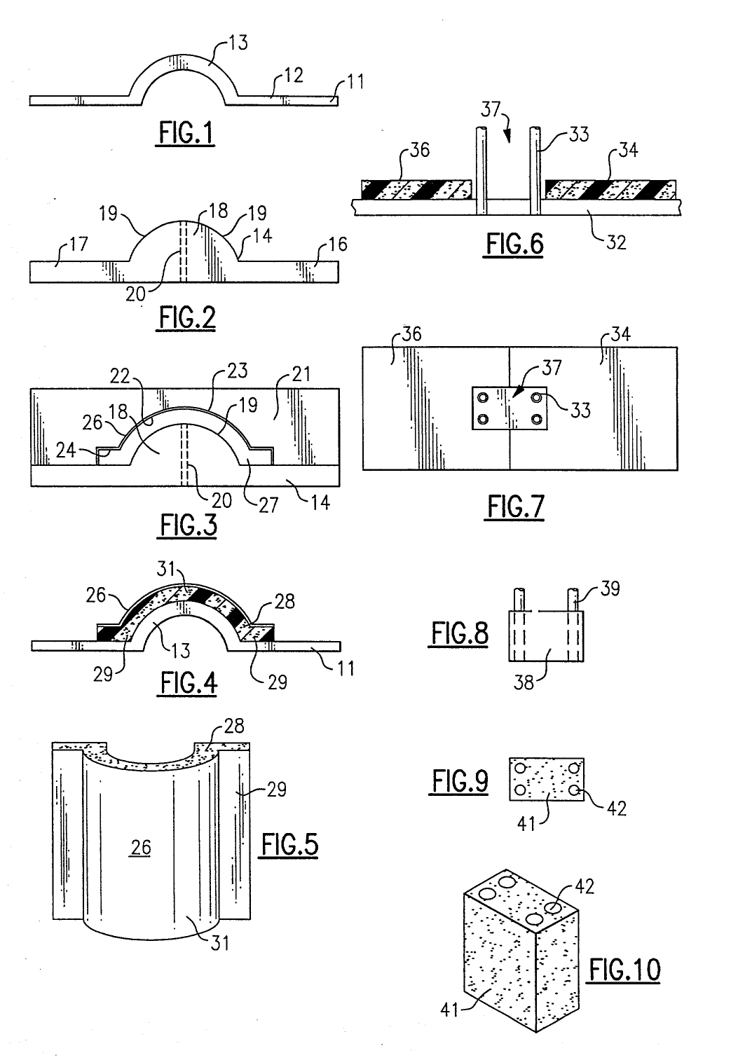

FIG. 1 shows a wall 11 of a body to be insulated, with the wall including a planar portion 12 and a non-planar portion 13. While the non-planar portion 13 may be of any shape, it is shown as semicircular in form for purposes of facilitating the description of the present invention.

The planar portion 12 can be easily insulated by using sections of planar insulation that can be easily attached to the wall planar portion 12 by adhesive or the like. It is the non-planar portion 13 which is more difficult to insulate and is a primary concern for purposes of applying the present invention.

In order to fabricate a non-planar panel, I propose to use a mold which, when filled with an appropriate liquid insulating material when dried, will provide the desired panel. Shown in FIG. 2 is a male mold element 14 having a pair of planar portions 16 and 17 with a non-planar portion 18 therebetween. The non-planar portion 18 has a surface 19 with a shape and size that corresponds with that of the non-planar portion 13 of the wall 11. A fill hole 20 passes through the non-planar portion 18 of the male mold element 14.

Shown in FIG. 3 is a male mold element 14 as it mates with a corresponding female mold element 21. The female mold element 21 includes an inner surface 22 with a non-planar portion 23 and a pair of planar wing surfaces 24. The non-planar surface 23 is of the same shape as the non-planar surface 19 of the male mold element 14. However, as will be seen, it is spaced from that non-planar surface 19 a distance which is substantially equal to the thickness of the insulation that is desired. The wing surfaces 24 are parallel to the planar portion 16 and 17 of the male mold element 14. The combination of male mold element 14 and female mold element 21 maybe filled with a liquid foam to form the insulating panel as desired. However, a preferred approach is to include a liner 26 that very closely approximates the shape of the inner surface 22 of the female mold element 21. The liner 26 can be of a metal or of a plastic material which is intended to provide protection for the insulation panel against abrasive and exposure to the sun. The liner 26 may also be a rather flexible material which can be placed loosely in the cavity 27 between the male and female elements, such that when the liquid insulating foam is inserted into the fill hole 20 the liner will be pressed against the inner surface 22 of the female element 21. While the liner may extend over the wing surfaces 24 as shown, it may also be used on only the non-planar surface 22 or portions thereof.

In any case, after the male and female elements are brought together to form the cavity 27 as shown in FIG. 3, the liquid insulating material is installed in the fill hole 20 until the cavity 27 is completely filled. The insulating material is preferable a thermosetting foam which is nonflammable and easy to work with in the liquid stage and which, when dried, will provide the desired insulating properties. One type of foam that would be useful for this purpose is urethane. Other possible materials include urea-formaldehyde or phenolic. Any of these foams will adhere to metal and plastics if the surfaces are clean.

Keeping in mind that most thermosetting foams are not resistant to ultra violet exposure or to abrasion, it may be necessary to protect the finished panel from those degrading elements. That is the purpose of the liner 26.

Shown in FIGS. 4 and 5 is a finished insulating panel 28 with its two planar wings 29 and its non-planar central portion 31. On the outer side thereof the liner 26 protects the panel from damage by exposure to ultra violet radiation and mechanical abrasion. On the inner side thereof, the shape and size is identical to the outer side of the wall 11 such that it can be fastened thereto by adhesive or the like. Planar wings 29 can be placed in abutting relationship to the adjoining planar sections of insulating panels, and the joint can be sealed by an adhesive or the like.

Shown in FIGS. 6 and 7 there is shown another type of deviation from a planar surface on a body which requires thermal insulation. Here, the body 32 is entirely planar except for four conduits 33 extending normally therefrom as shown. The planar portions surrounding the conduits 33 can be easily insulated by planar panels 34 and 36 as shown. However, for that area 37 between the conduits 33 and immediately surrounding the conduits, the planar sections cannot be used. The method of the present invention is therefore used to form a non-planar insulating panel. Thus, using the steps described hereinabove, a mold is fabricated to conform to the areas surrounding the non-planar portions of the body to be insulated, and a molded panel is fabricated to fit over these non-planer portions.

Shown in FIG. 8 is a mold 38 with upstanding rods 39 that are placed in positions corresponds to those of the conduits 33. The mold 38 is filled with liquid foam, which is then allowed to dry. The finished panel 41 can then be removed from the mold 38 and placed in position over the conduits 33, and between the two planar panels 34 and 36. It is preferably fixed in place by adhesive or the like.

If the panel 41 is formed in this manner, it is presumed that access can be gained to the ends of conduits 33 such that the panel can be slipped over the conduits 33, with the conduits 33 passing through the cylinder cavities 42.

Although not shown, a liner can be installed around the panel 41 in much the same way as described above by placing a protective liner material on the inner side of the mold 38 prior to inserting the foam material.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A method of forming an insulating panel to closely cover a non-planar portion of a structure to be thermally insulated, comprising the steps of:
forming a male mold element with an outer surface having a shape that corresponds with that of the non-planar portion;
forming a female mold element with an inner surface having a shape that corresponds with that of the non-planar portion;
coupling the male element with the female element with an offset between the respective inner surfaces to provide a cavity therebetween;
filling said cavity with a liquid foam material and allowing it to solidify to form a solid foam insulation element; and
removing said insulation panel from said mold element and attaching it to said non-planar portion.

2. A method as set forth in claim 1, wherein said offset is a distance equal to a certain desired thickness of the insulative element.

3. A method as set forth in claim 1, and including an additional step of placing a liner against said female mold inner surface prior to coupling the male and female elements.

4. A method as set forth in claim 3, wherein said liner is composed of a metal material.

5. A method as set forth in claim 3, wherein said liner is composed of a plastic material.

6. A method as set forth in claim 1, wherein said foam is of a thermosetting type.

7. A method as set forth in claim 6, wherein said foam is urethane.

8. A method as set forth in claim 6, wherein said foam is urea-formaldehyde.

9. A method as set forth in claim 6, wherein said foam is phenolic.

10. A method as set forth in claim 1, wherein said insulation element is attached to said planar portion by an adhesive.

11. An insulating panel for close fit installation over a non-planar portion of a structure to be thermally insulated, comprising;
a core element having an internal surface with a shape that corresponds to that of said non-planar portion and composed of a solid foam material which is generally susceptible to deterioration if exposed to sunlight or abrasive wear; and
a protective cover placed in close fit relationship with an outer side of said core element to protect it from exposure to sunlight and abrasive wear.

12. An insulating panel as set forth in claim 11, wherein said protective cover is composed of a metal material.

13. An insulating panel as set forth in claim 11, wherein said protective cover is made of a plastic material.

14. An insulating panel as set forth in claim 11, wherein said protective cover is bonded to said core element to form an integral panel.

15. An insulating panel as set forth in claim 11, wherein said core element is molded into said protective cover to form an integral panel.

16. An insulation structure covering a portion of a body to be thermally insulated, the body having a non-planar surface that joins a planar surface thereof comprising;
an non-planar element having a first edge and having an internal surface with a shape that corresponds to said body non-planar surface, said internal surface being disposed in close fit relationship with said non-planar surface, and said first edge being disposed over a portion of the planar surface;
a planar portion having a second edge and having a planar internal surface disposed in close fit relationship with said planar surface; and
said second edge being disposed in abutting relationship with said first edge.

17. An insulation structure as set forth in claim 16, wherein said molded non-planar element is susceptible to damage by exposure to sunlight and to abrasive wear and further wherein said non-planar element has a protective covering on the outer side thereof.

18. An insulation structure as set forth in claim 17, wherein said protective covering is composed of a metal material.

19. An insulation structure as set forth in claim 17, wherein said protective covering is composed of a plastic material.

20. An insulation structure as set forth in claim 16, wherein said non-planar element is secured to said non-planar surface by an adhesive.

21. An insulation structure as set forth in claim 16, wherein said first and second edges have sealant disposed therebetween.

22. An insulation structure as set forth in claim 21, wherein said sealant comprises an adhesive material.
